(19) United States
(12) Patent Application Publication
(10) Pub. No.: US 2026/0250909 A1
(43) Pub. Date: Aug. 27, 2026

(54) TREATMENT SYSTEM AND METHOD FOR MANUFACTURE OF PAPER, BOARD OR THE LIKE

(71) Applicant: KEMIRA OYJ, Helsinki (FI)

(72) Inventors: Matti HIETANIEMI, Espoo (FI); Asko KARPPI, Espoo (FI); Markus KORHONEN, Espoo (FI); Diego SALAS, Barcelona (ES)

(21) Appl. No.: 18/714,324

(22) PCT Filed: Dec. 16, 2022
(86) PCT No.: PCT/FI2022/050842

§ 371 Date: May 29, 2024

(30) Foreign Application Priority Data
Dec. 17, 2021 (FI) 20216295

(51) Int. Cl. D21H 17/00; D21F 11/00; D21H 17/37; D21H 17/43; D21H 17/45

(52) U.S. Cl. CPC D21H 17/72; D21F 11/00; D21H 17/375; D21H 17/43; D21H 17/45

(57) ABSTRACT

The invention relates to a treatment system and its use in manufacture of paper, board or the like, from recycled cellulosic fibres. The treatment system comprises, as separate components, a cationic polymeric component having a charge density from +2.5 meq/g to +6.5 meq/g, at pH 7, and an anionic component having a charge density from −3.0 meq/g to −0.03 meq/g, preferably from −2.5 meq/g to −0.03 meq/g, at pH 7. The anionic component is a mixture comprising i) cationic starch, and ii) acarboxymethyl cellulose having a charge density from −4.5 meq/g to −2 meq/g, and/or an anionic copolymer obtained by polymerisation of acrylamide and 1-60 mol-% of anionic monomers.

The present invention relates to a treatment system and a method for manufacture of paper, board or the like according to the preambles of the enclosed independent claims.

Environmental issues have been one of the important topics in manufacture of paper, board and the like already for decades. Attention has been concentrated, among others, on use of raw materials, especially to the effective use of cellulosic fibres and water, which are the main raw material constituents of the process. For example, the recycling degree of cellulosic fibre material in manufacture of paper, board and the like has steadily increased during the last decades. This means that cellulosic fibres are repeatedly being repulped and formed into new fibrous products before they are definitely discarded from the process cycle. During every repulping occasion the properties of the fibres are deteriorated: they become shorter, lose part of their flexibility and part of their strength. At the same time the water circulations of the manufacturing process have become more closed, as there may be limitations to the availability of clean incoming water and/or environmental permissions of the mills may limit the allowed amount of effluent water and COD (chemical oxygen demand) load in the effluent. The allowable effluent water amount may even become a limiting factor for water consumption. This means that the intake of fresh water to the mill is minimised and the same water is being cleaned and recirculated within the process. This has increased especially conductivity and the amount of anionically charged substances in the process water.

Traditionally various charged chemicals, such as cationically charged polymers, have been used to improve the strength properties of produced cellulosic fibrous webs, such as paper, board or the like. The function of these strength chemicals has been based on electrostatic interactions. As the cellulosic fibres have usually negative surface charge, the charge of the strength chemicals has been conventionally optimised for the interaction with negatively charged fibres. However, as explained above, nowadays the repeated repulping makes the fibres less negatively charged, i.e. the fibres lose their surface charge. At the same time the amount of competing negatively charged particles and compounds in the process water has been increasing. This has complicated the use of traditional chemical strength additives in the manufacturing process of paper, board or the like. It has been observed that some conventional strength agents cannot provide the expected improvement in strength properties, especially when used for making paper or board from recycled cellulosic fibres.

WO 2018/055239 discloses a method for making of paper, board or the like. In the method a cationic strength agent is added to the fibre stock. A dry strength composition is added to the fibre stock before or after the addition of the cationic strength agent. The dry strength composition comprises a mixture of a synthetic polymer component and a cationic starch component and having a charge density in a range from −3 to −0.2 meg/g at pH 7.

One possibility to improve the strength properties of paper or board is surface sizing, especially when the strength additives, which are added to the fibre stock, do not provide desired strength response. However, surface sizing requires additional process equipment and increases the number of process steps in the manufacturing process. Consequently, there is a need to find new effective treatment systems, substances or compositions, which could be used to increase the dry strength properties of the produced paper and board by addition to the fibre stock. The desired treatment system should be especially suitable for manufacturing processes using recycled fibres.

An object of this invention is to minimise or even eliminate the disadvantages existing in the prior art.

An object is also to provide a treatment system and a method which provide effective increase in strength properties of the final paper, board or the like, especially comprising recycled cellulosic fibres.

These objects are attained with the invention having the characteristics presented below in the characterising parts of the independent claims. Some preferable embodiments are disclosed in the dependent claims.

The embodiments mentioned in this text relate, whenever applicable, to all aspects of the invention, both the treatment system, its use and the method, even if this is not always separately mentioned.

A typical treatment system according to the present invention for manufacture of paper, board or the like from recycled cellulosic fibres, comprises, as separate components,
a cationic polymeric component having a charge density from +2.5 meq/g to +6.5 meq/g, at pH 7, and
an anionic component having a charge density from −3.0 meq/g to −0.03 meq/g, preferably from −2.5 meq/g to −0.03 meq/g, at pH 7, which anionic component is a mixture comprising
   i) cationic starch, and
   ii) a carboxymethyl cellulose having a charge density from −4.5 meq/g to −2 meq/g, and/or an anionic copolymer obtained by polymerisation of acrylamide and 1-60 mol-% of anionic monomers.

Typical use according to the present invention of the inventive treatment system is for improving strength properties, especially SCT strength, of a paper, board or the like comprising recycled cellulosic fibres.

Typical method according to the invention for manufacture of paper, board or the like, comprises
obtaining a fibre stock comprising recycled cellulosic fibres and having a consistency of ≥2.5 weight-%,
adding a cationic polymeric component and the anionic component of a treatment system according to the invention to the fibre stock, separately and in this order,
diluting the fibre stock to a consistency <2.5 weight-%, and
forming the fibre stock into a fibre web and drying the formed fibre web.

Now it has been surprisingly found that a treatment system, which comprises a specific cationic polymeric component having a charge density from +2.5 meq/g to +6.5 meq/g provides improved strength effect, especially in manufacture of fibre webs, such as paper and board, which comprise or consists of recycled cellulosic fibres. The specific cationic polymeric component is especially advantageous for manufacture of multi-ply fibre webs, such as multi-ply board, when used together with the specific anionic component. The cationic polymeric component of the treatment system has a high cationic charge: this enables its interaction with fibres with reduced anionic surface charge, even in environments comprising competing anionic charge. It is assumed, without wishing to be bound by a theory, that a part of the cationic charge may be consumed by the competing negatively charged particles and compounds. Irrespective of this, cationic sites can still be created on the surface of the fibres. These sites then further interact with the anionic component of the treatment system and provide a network of chemical bonds and interactions necessary for creating the desired strength effect in produced paper, board or the like. By using the treatment system according to the present invention it is thus possible to achieve unexpected increase in strength properties of the final product, especially in SCT and burst strength, even when fibre stock comprising or consisting of recycled fibres, with high conductivity and low zeta potential is used as raw material.

The treatment system of the present invention denotes a chemical dosage regime, suitable for use in manufacture of paper, board or the like. The treatment system according to the present invention comprises, as separate components, a cationic polymeric component and an anionic component. The cationic polymeric component and the anionic component are added to the fibre stock separately from each other. Preferably the cationic polymeric component is added before the addition of the anionic component. In this manner the cationic polymeric component can effectively interact with the weak anionic charges of the recycled cellulosic fibres and create cationic anchoring sites for the anionic component of the treatment system. Furthermore, when the cationic polymeric component is added to the fibre stock before the addition of the anionic component, the risk for unwanted floc formation in the fibre stock is reduced. In some embodiments, however, the reverse addition order, where the anionic component is added before the cationic polymeric component, is possible.

The cationic polymeric component suitable for use in the present invention may have a charge density from +2.5 meq/g to +6.5 meq/g, preferably from +3 meq/g to +6 meq/g, preferably from +3.5 meq/g to +5.5 meq/g, measured at pH 7. The charge density of the cationic polymeric component is much higher than in conventional cationic strength agents. It was unexpected that the high cationic charge density was able to interact with the anionic component in a fibre stock comprising or consisting of recycled fibres and provide improved strength properties without negative effects, such as unwanted flocculation.

According to one preferable embodiment of the invention the cationic polymeric component may comprise a cationic copolymer, which is obtained by polymerising (meth)acrylamide and cationic monomers. The cationic polymeric component may be obtained by using any suitable polymerisation method, such as solution polymerisation, dispersion polymerisation or emulsion polymerisation. The cationic monomer may be selected from a group comprising 2-(dimethylamino)ethylacrylate (ADAM), [2-(acryloyloxy)ethyl] trimethylammonium (ADAM-CI), 2-(dimethylamino)ethyl acrylate benzylchloride, 2-(dimethylamino)ethyl acrylate dimethylsulphate, 2-(dimethylamino)ethyl methacrylate (MADAM), [2-(methacryloyloxy)ethyl] trimethylammonium chloride (MADAM-CI), 2-dimethyl-aminoethyl methacrylate dimethylsulphate, [3-(acryloylamino)propyl] trimethylammonium chloride (APTAC), [3-(methacryloylamino)propyl] trimethylammonium chloride (MAPTAC), diallyldimethylammonium chloride (DADMAC) or any of their mixtures. Preferably the cationic monomer may be [2-(acryloyloxy)ethyl] trimethylammonium chloride (ADAM-CI).

According to one embodiment of the invention the cationic polymeric component may comprise or consists of a cationic copolymer, which is obtained by polymerising (meth)acrylamide and 23-70 mol-%, preferably 30-70 mol-%, more preferably 30-60 mol-%, of cationic monomers, as defined above. It is even possible that the cationic copolymer may comprise anionically charged groups, as long as the overall charge of the copolymer is cationic and within the specified range. For example, the cationic copolymer may be obtained by polymerising (meth)acrylamide and 23-70 mol-%, preferably 30-70 mol-%, more preferably 30-60 mol-%, of cationic monomers and 1-10 mol-%, preferably 1-5 mol-%, more preferably 1-3 mol-% of anionic monomers. The anionic monomers may be selected from unsaturated mono- or dicarboxylic acids, such as acrylic acid, maleic acid, fumaric acid, itaconic acid, aconitic acid, mesaconic acid, citraconic acid, crotonic acid, isocrotonic acid, angelic acid or tiglic acid. Preferably the anionic groups originate from acrylic acid.

The cationic copolymer, obtained by polymerising (meth)acrylamide and cationic monomers and optionally anionic monomers, may be linear or crosslinked, e.g. by using methylenebisacrylamide (MBA).

According to another preferred embodiment the cationic polymeric component comprises a combination of (i) a cationic copolymer obtained by polymerisation of (meth)acrylamide and at least one cationic monomer as described above, and (ii) a cationic auxiliary polymer selected from polyamines, such as polyvinylamine polymer, and from homopolymers of cationic monomers, such as diallyldimethylammonium chloride (DADMAC), [2-(acryloyloxy)ethyl] trimethylammonium chloride (ADAM-CI) or [3-(acryloylamino)propyl] trimethylammonium chloride (APTAC). According to one preferred embodiment the cationic polymeric component is a combination of (i) a cationic copolymer obtained by polymerisation of (meth)acrylamide and at least one cationic monomer as described above, and (ii) polydiallyldimethylammonium chloride (poly-DADMAC). The cationic polymeric component may be obtained by mixing the cationic copolymer and the cationic auxiliary polymer together or by polymerising the cationic copolymer in a presence of the cationic auxiliary polymer. The cationic polymeric component may contain 25-70 weight-%, preferably 30-70 weight-% of cationic auxiliary polymer selected from polyamine and homopolymers of cationic monomers.

When the cationic polymeric component comprises a combination of the cationic copolymer and the cationic auxiliary polymer, as defined above, the cationic copolymer may preferably be obtained by polymerisation of (meth)acrylamide and 5-50 mol-%, preferably 6-35 mol-%, of at least one cationic monomer as described above. For example, the cationic copolymer may be preferably obtained by polymerisation of (meth)acrylamide and 20-35 mol-%, preferably 20-30 or 25-35 mol-%, of at least one cationic monomer.

It has been observed that the presence of the cationic auxiliary polymer, especially polydiallyldimethylammonium chloride, is advantageous in the cationic polymeric component, especially when the fibre stock has a high cationic demand. It is assumed that the cationic auxiliary polymer, preferably polydiallyldimethylammonium chloride, provides for interaction with the negatively charged species present in the fibre stock while enabling the effective interaction of the cationic copolymer with the weakly negative surfaces of the recycled fibres, which creates the network needed for improving the strength properties.

According to one preferable, embodiment the cationic polymeric component comprises a mixture of polydiallyldimethylammonium chloride (poly-DADMAC) and the cationic copolymer obtained by polymerisation of (meth)acrylamide and 5-50 mol-%, preferably 6-35 mol-%, of at least one cationic monomer as described above. The mixture may comprise poly-DADMAC and the cationic copolymer in a weight ratio of 80:20-20:80, preferably 75:25-25:75, more preferably 67:33-33:67, given as dry polymer.

Alternatively, the cationic polymeric component may comprise a cationic copolymer obtained by polymerisation of (meth)acrylamide and 5-50 mol-%, preferably 6-35 mol-%, of at least one cationic monomer, as defined above, in a presence of polydiallyldimethylammonium chloride (poly-DADMAC). The cationic polymeric component may contain 25-70 weight-%, preferably 30-70 weight-% of polydiallyldimethylammonium chloride.

The polydiallylmethylammonium chloride, which is present during polymerisation of the cationic copolymer or which is mixed with the cationic copolymer, may have a weight average molecular weight in a range of 50 000-1 000 000 g/mol, preferably 60 000-500 000 g/mol, more preferably 75 000-400 000 g/mol. It has been observed that these ranges offer very effective interaction with the negatively charged species in the fibre stock over a very wide pH range.

According to one embodiment the cationic polymeric component may comprise or consists of a polyvinylamine polymer. For example, the cationic polymeric component may comprise a combination of a cationic copolymer obtained by polymerisation of (meth)acrylamide and at least one cationic monomer as described above, and a cationic auxiliary polymer which is polyvinylamine polymer. Suitable polyvinylamine polymer may be obtained by polymerising N-vinylformamide and then hydrolysing part of the obtained polyvinylformamide into polyvinylamine units. Suitable polyvinylamine polymer may comprise 15-70 mol-%, preferably 15-60 mol-%, more preferably 15-50 mol-%, of polyvinylamine units, calculated from the total polymer, including both polyvinylamine and polyvinylformamide units.

The cationic copolymer obtained by polymerisation of (meth)acrylamide and at least one cationic monomer, as described above, may have a weight average molecular weight in a range of 300 000-5 000 000 g/mol, more preferably 500 000-5 000 000 g/mol, even more preferably 1 000 000-4 000 000 g/mol. It has been observed that these weight ranges, combined with the amount of cationic monomer, gives the desired interaction with the weakly negative surfaces of the recycled fibres and creates the network needed for improved strength properties, without initiating formation of large flocs, which would be detrimental for strength properties and web formation.

The weight average molecular weights for the present purposes, up to the weight average molecular weight of 1 000 000 g/mol, are measured by using SEC/GPC determination with polyethyleneoxide (PEO) calibration: the weight average molecular weight is determined by size-exclusion chromatography (SEC) using Agilent 1100 SE chromatography equipment with integrated pump, autosampler and degasser. Used eluent is a buffer solution (0.3125 M CH₃COOH+0.3125 M CH₃COONa) with a flow rate of 0.5 ml/min at 35° C. Typical sample concentration is 2-4 mg/ml, with an injection volume of 50 μl. Ethylene glycol (1 mg/ml) is used as a flow marker. Column set consists of three columns: a TSKgel PWXL guard column and two TSKgel GMPWXL columns. Refractive index detector by Agilent is used for detection (T=35° C.). Molecular weight is determined using conventional (column) calibration with poly(ethylene oxide)/poly(ethylene glycol) narrow molecular weight distribution standards (Polymer Standards Service).

The weight average molecular weight higher than 1 000 000 g/mol are determined by measuring the standard viscosity of the polymer and then estimating weight average molecular weight from a correlation curve based on experimental measurements. In general, the standard viscosity of the polymer gives an indication of the length and/or weight of the polymer chains of the polymer. Standard viscosity (SV) is measured at 0.1 weight-% polymer content in an aqueous 1 M NaCl solution, using Brookfield LV viscometer equipped with UL adapter, at 25° C., using UL Adapter Spindle and rotational speed 60 rpm. A correlation curve for weight average molecular weights higher than 1 000 000 g/mol can be made by determining standard viscosity (SV) and intrinsic viscosity (IV) of the polymer. The weight average molecular weight (MW) is calculated from IV results using Mark-Houwink-Sakurada constants K=2.57×10⁻⁴ dl/g and a=0.67, which are fitted for conditions 1 M NaCl at 25° C., for range 1.1×10⁶-1.5×10⁷ g/mol (Dautzenberg et al., Polyelectrolytes. Formation, Characterization and Application, Carl Hanser Verlag, Munich Vienna New York, 1994, pp. 222-223). The weight average molecular weights obtained by this method are directive. As a general guideline, a correlation between standard viscosity, intrinsic viscosity and weight average weight molecular weight of a cationic copolymer of (meth)acrylamide may be assumed, as shown in Table 1.

TABLE 1
General correlation between standard viscosity, intrinsic
viscosity and weight average weight molecular weight
of a cationic copolymer of (meth)acrylamide.

| Standard | Intrinsic | Weight Average |
|---|---|---|
| Viscosity, SV | Viscosity, IV | Molecular Weight, MW |
| [mPas] | [dl/g] | [g/mol] |
| 2 | 4.8 | 1 300 000 |
| 2.5 | 6.7 | 3 400 000 |
| 3 | 8.5 | 5 500 000 |
| 3.5 | 10.4 | 7 600 000 |
| 4 | 12.3 | 9 800 000 |
| 4.5 | 14.1 | 12 000 000 |
| 5 | 16.0 | 14 000 000 |
| 5.5 | 17.9 | 16 000 000 |
| 6 | 19.7 | 18 000 000 |
| 6.5 | 21.6 | 20 000 000 |
| 7 | 23.5 | 23 000 000 |

The treatment system of the present invention comprises, in addition to the cationic polymeric component as defined above, an anionic component, which has a charge density from −3.0 meq/g to −0.03 meq/g, preferably from −2.5 meq/g to −0.03 meq/g, at pH 7. The charge density of the anionic component provides an effective interaction with the cationic polymeric component and enables the achievement of the improved strength effect. The formed polymeric network has a large dimension, which improves the strength properties of the formed fibre web comprising or consisting of recycled cellulosic fibres.

The anionic component of the treatment system is a mixture comprising i) cationic starch, and ii) a carboxymethyl cellulose and/or an anionic copolymer obtained by polymerisation of acrylamide and 1-60 mol-% of anionic monomers. The anionic component thus comprises both cationic groups, which originate from the cationic starch, and anionic groups, which mainly originating from the carboxymethyl cellulose and/or anionic copolymer. The net charge of the anionic component is, however, anionic, measured at pH 7.

According to one embodiment of the invention the anionic component may comprise 10-90 weight-%, preferably 30-70 weight-%, more preferably 40-60 weight-%, of the carboxymethyl cellulose and/or anionic copolymer, and 10-90 weight-%, preferably 30-70 weight-%, more preferably 40-60 weight-% of the cationic starch component, calculated from the dry weight of the anionic component. According to one preferable embodiment of the invention the ratio of the carboxymethyl cellulose and/or anionic copolymer to the cationic starch component is 40:60-60:40, given as dry weights. The ratio is chosen so that the anionic component is net anionic at the pH of the fibre stock.

The anionic component of the treatment system may comprise or consists of carboxymethyl cellulose having a charge density from −4.5 meq/g to −2 meq/g, preferably from −4.0 meq/g to −2.5 meq/g, more preferably from −4.0 meq/g to −3.0 meq/g. The carboxymethyl cellulose may have a weight average molecular weight MW in the range of 250 000-750 000 g/mol, preferably 300 000-600 000 g/mol. Use of carboxymethyl cellulose increases the amount of bio-based components in the treatment system and helps to reduce the amount of non-renewable components. Furthermore, the linear structure of the carboxymethyl cellulose and its molecular weight, as defined above, is advantageous for the structure of the anionic component, creating with the cationic starch component high physical dimensions for the anionic component.

The anionic component of the treatment system may comprise or consists of anionic copolymer obtained by polymerisation of acrylamide and 1-60 mol-% of anionic monomers. According to one embodiment the anionic copolymer of the anionic component may be obtained by polymerisation of (meth)acrylamide and at least one anionic monomer, which is selected from unsaturated mono- or dicarboxylic acids, such as acrylic acid, methacrylic acid, maleic acid, itaconic acid, crotonic acid, isocrotonic acid, and any of their mixtures, or their salts. The anionic copolymer may be obtained by polymerisation of (meth)acrylamide and 3-40 mol-%, preferably 5-25 mol-%, more preferably 5-20 mol-%, sometimes 9-15 mol-%, of anionic monomers.

The anionic copolymer of the anionic component may be linear or crosslinked. If the anionic copolymer is crosslinked, a suitable crosslinker is used in the polymerisation in amount of 50-1000 mg/kg monomers, preferably 50-500 mg/kg monomers. Suitable crosslinkers are, for example, methylenebisacrylamide, ethylene glycol divinyl ether, di(ethylene glycol) divinyl ether, and tri(ethylene glycol) divinyl ether. Methylenebisacrylamide is a preferable crosslinker.

The anionic copolymer of the anionic component may be prepared by any suitable polymerisation method, such as solution polymerisation, dispersion polymerisation, emulsion polymerisation or gel polymerisation. According to one embodiment the anionic copolymer may be obtained by solution polymerisation and the anionic copolymer may have a weight average molecular weight MW in the range of 300 000-1 000 000 g/mol, preferably 400 000-1 000 000 g/mol, more preferably 500 000-900 000 g/mol. According to another embodiment the anionic copolymer may be obtained by gel polymerisation and the anionic copolymer may have a weight average molecular weight MW in the range of 2 000 000-10 000 000 g/mol, preferably 2 500 000-8 000 000 g/mol, more preferably 3 000 000-6 000 000 g/mol. Anionic copolymer obtained by gel polymerisation are usually available as dry polymers, which is advantageous in view of microbial stability as well as in view of transport and storage.

According to one embodiment the anionic component comprises both carboxymethyl cellulose and anionic copolymer, i.e. the anionic component is a mixture of carboxymethyl cellulose and anionic copolymer.

The cationic starch present in the mixture forming the anionic component may be cationic non-degraded starch. In the present context this means starch, which has been modified solely by cationisation, and which is non-degraded and non-cross-linked. Non-degraded starch preferably comprises starch units of which at least 70 weight-%, preferably at least 80 weight-%, more preferably at least 85 weight-%, even more preferably at least 90 weight-%, sometimes even more preferably at least 95 weight-%, have an average molecular weight MW over 20 000 000 g/mol, preferably over 50 000 000 g/mol, more preferably over 100 000 000 g/mol, sometimes even over 200 000 000 g/mol.

The cationic starch be any cationic starch having the required cationicity, for example potato, waxy potato, rice, corn, waxy corn, wheat, barley, sweet potato or tapioca starch, or any of their mixtures. In some embodiments the cationic starch may have an amylopectin content >70%, preferably >80%, more preferably >85%, even more preferably >90%, sometimes even more preferably >95%.

The cationic starch may have a substitution degree of 0.025-0.3, preferably 0.03-0.16, more preferably 0.045-0.1. The substitution degree is relative to the cationicity of the starch. Cationic starches having relatively high cationicity as defined are preferred for use in the dry strength composition as they provide the improved dry strength effect for the final paper or board.

When mixed with carboxymethyl cellulose and/or anionic copolymer for forming the anionic component the cationic starch is preferably in form of an aqueous solution, which means that the starch has been dissolved in water, e.g. by cooking at a temperature of 60-135° C.

The individual constituents of the anionic component may be mixed with each other before the addition of the anionic component to the fibre stock, i.e. the anionic component is added to the fibre stock as a single solution. The constituents, i.e. carboxymethyl cellulose, anionic copolymer and cationic starch, are in form of a solution or dispersion at the time of mixing. Preferably the cationic starch and the anionic copolymer and/or carboxymethyl cellulose are allowed to interact with each other before the anionic component is added to the fibre stock in order to guarantee the formation of a polyionic complex.

The treatment system is suitable for improving one strength property or simultaneously several strength properties of a paper, board or the like, wherein the strength property/-ies are especially selected from SCT (Short-span Compression Test) strength, burst strength and CMT (Concora Medium Test) strength.

The cationic polymeric component and the anionic component of the treatment system are added to the fibre stock having a consistency of ≥2.5 weight-%, preferably ≥3 weight-%, separately and in this order.

The fibre stock comprising or consisting of recycled fibres and having a consistency ≥2.5 weight-% may have a cationic demand ≥300 μeq/l, sometimes even ≥400 μeq/l. The cationic demand may be, for example, in a range of 300-2500 μeq/l, typically 400-2000 μeq/l. The fibre stock may further have a conductivity of ≥2 or ≥3 mS/cm, preferably >4 mS/cm, sometimes even ≥5 mS/cm. According to one embodiment the conductivity of the fibre stock may be in a range of 2-20 mS/cm, typically 3-15 mS/cm, sometimes even 4-15 mS/cm. The cationic demand for the fibre stock is measured from a filtrate, obtained by filtrating the fibre stock through a black ribbon filter paper, e.g. from Schleicher & Schuell.

According to one embodiment, the paper, board or the like is produced in an industrial process, where the process has a fresh water intake <5 m³/ton, sometimes even <3 m³/ton, i.e. metric ton, of produced paper, board or the like. For example, when the fresh water intake of the process is <5 m³/ton, the conductivity of the fibre stock may typically be ≥3 mS/cm. When the fresh water intake of the process is <3 m³/ton, the conductivity of the fibre stock may typically be ≥5 mS/cm.

The fibre stock may have zeta-potential from −15 mV to −2 mV, preferably from −10 mV to −4 mV.

The fibre stock may preferably comprise at least 80 weight-%, more preferably at least 90 weight-%, even more preferably at least 95 weight-%, of recycled cellulosic fibres. According to one preferable embodiment the fibre stock consists of recycled cellulosic fibres. Recycled fibres in the sense of the present application thus preferably do not include broke.

The cationic polymeric component of the treatment system is added in an amount of 0.2-1.5 kg/ton dry stock, preferably 0.2-1 kg/ton dry stock.

The anionic component may be added in amount of 0.5-4 kg/ton dry fibre stock, preferably 0.5-3.5 kg/ton dry fibre stock, more preferably 0.75-2 kg/ton dry fibre stock.

According to one embodiment of the invention the components of the treatment system are added in such amounts that zeta potential of the fibre stock is remains negative.

The treatment system according to present invention is suitable for improving dry strength of the board web when producing paperboard like liner, testliner, fluting, folding boxboard (FBB), white lined chipboard (WLC), solid bleached sulphate (SBS) board, solid unbleached sulphate (SUS) board or liquid packaging board (LPB), but not limited to these. Boards may have grammage from at least 80 g/m² or at least 120 g/m², for example in a range from 80 g/m² to 500 g/m² or from 120 g/m² to 500 g/m².

### EXPERIMENTAL

Some embodiments of the present invention are disclosed in the following non-limiting example.

### Example 1

Example 1 illustrates the effect of a chemical treatment system comprising a cationic polymeric component and an anionic component on various strength properties of the produced fibre web. The tested strength properties were short span compression strength (SCT), burst strength and crushing resistance (Corrugating Medium Test, CMT30) and the methods used for their measurement are given in Table 2.

TABLE 2
Measured properties and standard
methods used for produced sheets.

| Measurement | Device | Standard |
|---|---|---|
| Basis weight | Mettler Toledo | ISO 536 |
| Short Span Compression test (SCT) | Lorentzen & Wettre | ISO 9895 |
| Burst strength | Lorentzen & Wettre | ISO 2758 |
| Corrugating Medium Test (CMT30) | Lorentzen & Wettre | ISO 7263 |

Fibre stock was prepared from European recycled board (RCF).

Test sheets having a basis weight of 110 g/m², were formed with Rapid Koethen sheet former (RK). The test sheets were formed as follows:

RCF was wet disintegrated, without prior soaking, at 3 weight-% consistency at temperature 70° C. with Noviprofibre-pulper. Wet disintegration was started at 500 rpm first for 30 sec, and continued for 25 min at 1000 rpm. The fibre stock obtained through wet disintegration was diluted to consistency of 0.5 weight-% with tap water. pH and conductivity of the diluted fibre stock adjusted to pH 6.8 and conductivity 3.0 mS/cm.

All test points included retention aids, 100 g/t of cationic polyacrylamide (charge density ca 1 meq/g, standard viscosity 3.3 mPas) and 400 g/t of silica microparticles (Fennosil 2180, Kemira Oyj).

Anionic component was a mixture of cationic waxy starch (DS 0.07, charge density 0.4 meq/g) and anionic polyacrylamide (weight average molecular weight 500 000 g/mol, charge density-1.5 meq/g). The anionic component had a charge density of −0.6 meq/g, at pH 7.

Additions of the used chemicals were made to the fibre stock in a mixing vessel, at mixing speed 1000 rpm, as follows:
1. cationic polymeric component, at −60 s;
2. anionic component, at −40 s;
3. cationic polyacrylamide (retention aid), at −15 s;
4. silica microparticles (retention aid), at −10 s.

After additions of the used chemicals, at moment 0 s, the fibre stock was poured to RK sheet former and water was drained out through wire with suction. The formed sheet was removed from the wire and vacuum dried at 92° C. in restrain. Before testing in the laboratory, the sheets were pre-conditioned for 24 h at 23° C. in 50% relative humidity, according to the standard ISO 187.

Cationic polymeric components are defined in Table 3. [2-(acryloyloxy)ethyl] trimethylammonium chloride was used as cationic monomer in all cationic polyacrylamides.

TABLE 3
Cationic polymeric components used in Example 1.

| Cationic | Charge | Standard | Weight Average | |
|---|---|---|---|---|
| Polymeric | Density* | Viscosity | Molecular Weight | |
| Component | [meq/g] | [mPas] | [g/mol] | Chemistry |
| CP1 | 3.7 | 2.1 | 1 800 000 | Mixture of 50 w-% poly- |
| | | | | DADMAC and 50 w-% |
| | | | | cationic polyacrylamide |
| | | | | (10 mol-%) |
| CP2 | 2.8 | 1.8 | 1 000 000 | Cationic polyacrylamide, |
| | | | | emulsion polymer |
| CP4 | 4.8 | 1.3 | 260 000 | Polyvinylamine polymer, 30 |
| | | | | mol-% polyvinylamine/70 |
| | | | | mol-% polyvinylformamide |
| CP5 | 4.0 | 2.5 | 3 400 000 | Mixture of 50 w-% poly- |
| | | | | DADMAC and 50 w-% |
| | | | | cationic polyacrylamide |
| | | | | (15 mol-%) |
| CP3 | 2.1 | 4.5 | 11 900 000 | Cationic polyacrylamide, |
| (reference) | | | | emulsion polymer |
| CP6 | 2.2 | — | 330 000 | Polyamidoamine |
| (reference) | | | | epichlorohydrin |
| CP7 | 0.6 | 3.3 | 6 700 000 | Cationic polyacrylamide |
| (reference) | | | | |

*measured at pH 7

The used amounts of cationic polymeric components are indicated in Table 4. The amount of anionic component was 1.4 kg/t in all experiments. All chemical amounts are given as kg dry chemical per ton dry RCF fibre stock.

The results of Example 1 are shown in Table 4. It can be seen that all treatment system according to the invention, where the cationic polymeric component has charge density >2.5 meq/g, improves the SCT index already at low dosage amounts (Test 1). At a higher dosage, a significant increase in both SCT index and burst index can be observed (Test 4). Furthermore, when the charge density of the cationic polymeric component increases, the SCT index, burst index and CMT30 value are all substantially improved (Tests 7-9). This is highly unexpected, as for reference systems, where the cationic polymeric component has a charge density <2.5 meq/g, no such general improvement can be seen (Tests 3, 5, 6, 10). On the contrary, for reference systems no improvement in burst index was observed.

TABLE 4
Results of Example 3.

| | | | SCT | Burst | |
|---|---|---|---|---|---|
| | Cationic Polymeric | Dosage | index | index | CMT30 |
| Test | Component | [kg/t] | [Nm/g] | [kPam²/g] | [Nm²/g] |
| 1 | 0-test | — | 20.78 | 1.92 | 0.90 |
| | (no strength additive) | | | | |
| 2 | CP2 | 0.35 | 21.62 | 1.90 | 0.93 |
| 3 | CP3 | 0.35 | 20.91 | 1.91 | 0.93 |
| | (reference) | | | | |
| 4 | CP2 | 0.5 | 21.87 | 2.11 | 0.96 |
| 5 | CP3 | 0.5 | 21.24 | 1.86 | 0.90 |
| | (reference) | | | | |
| 6 | CP6 | 0.5 | 21.52 | 1.95 | 0.93 |
| | (reference) | | | | |
| 7 | CP1 | 0.7 | 23.81 | 2.34 | 1.03 |
| 8 | CP4 | 0.7 | 23.27 | 2.39 | 1.01 |
| 9 | CP5 | 0.7 | 22.84 | 2.15 | 1.01 |
| 10 | CP7 | 0.7 | 21.59 | 1.75 | 0.99 |
| | (reference) | | | | |

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. A treatment system for manufacture of paper, board or the like, from recycled cellulosic fibres, the treatment system comprising, as separate components,
a cationic polymeric component having a charge density from +2.5 meq/g to +6.5 meq/g, at pH 7, and
an anionic component having a charge density from −3.0 meq/g to −0.03 meq/g, preferably from −2.5 meq/g to −0.03 meq/g, at pH 7, which anionic component is a mixture comprising
i) cationic starch, and
ii) a carboxymethyl cellulose having a charge density from −4.5 meq/g to −2 meq/g, and/or an anionic copolymer obtained by polymerisation of acrylamide and 1-60 mol-% of anionic monomers.

2. Treatment system according to claim 1, wherein the cationic polymeric component comprises a cationic copolymer obtained by polymerising (meth)acrylamide and 30-70 mol-%, preferably 30-60 mol-%, of cationic monomers, the cationic copolymer preferably having a weight average molecular weight in a range of 300 000-5 000 000 g/mol.

3. The treatment system according to claim 1, wherein the cationic polymeric component comprises a combination of a cationic copolymer obtained by polymerisation of (meth)acrylamide and at least one cationic monomer, and a cationic auxiliary polymer selected from polyamine and homopolymers of cationic monomers.

4. The treatment system according to claim 3, wherein the cationic auxiliary polymer is a homopolymer of diallyldimethylammonium chloride (DADMAC), [2-(acryloyloxy)ethyl] trimethylammonium chloride (ADAM-C1) or [3-(acryloylamino)propyl]trimethylammonium chloride (APTAC).

5. The treatment system according to claim 1, wherein the cationic polymeric component comprises a cationic copolymer obtained by polymerising (meth)acrylamide and 5-50 mol-%, preferably 6-35 mol-%, of cationic monomer in a presence of poly-DADMAC.

6. The treatment system according to claim 1, wherein the cationic polymeric component comprises a mixture of poly-DADMAC and a cationic copolymer obtained by polymerising (meth)acrylamide and at least cationic monomer.

7. The treatment system according to claim 6, wherein the mixture comprises poly-DADMAC and the cationic copolymer in a weight ratio of 80:20-20:80, preferably 75:25-25:75, more preferably 67:33-33:67, given as dry polymer.

8. The treatment system according to claim 4, wherein the poly-DADMAC has a weight average molecular weight 50 000-1 000 000 g/mol, preferably 60 000-500 000 g/mol, more preferably 75 000-400 000 g/mol.

9. The treatment system according to claim 1, wherein the cationic polymeric component comprises polyvinylamine.

10. The treatment system according to claim 1, wherein the carboxymethyl cellulose has a weight average molecular weight MW in the range of 250 000-750 000 g/mol, preferably 300 000-600 000 g/mol, and/or the charge density from −4.0 meq/g to −2.5 meq/g.

11. The treatment system according to claim 1, wherein the anionic copolymer is obtained by polymerisation of acrylamide and at least one anionic monomer, which is selected from unsaturated mono- or dicarboxylic acids, such as acrylic acid, methacrylic acid, maleic acid, itaconic acid, crotonic acid, isocrotonic acid, and any of their mixtures, or their salts.

12. The treatment system according to claim 1, wherein the anionic copolymer is obtained by polymerisation of acrylamide and 3-40 mol-%, preferably 5-25 mol-%, more preferably 5-20 mol-%, of anionic monomers.

13. The treatment system according to claim 1, wherein the anionic copolymer is obtained by solution polymerisation and has a weight average molecular weight MW in the range of 300 000-1 000 000 g/mol, preferably 400 000-1 000 000 g/mol, more preferably 500 000-900 000 g/mol.

14. The treatment system according to claim 1, wherein the anionic copolymer is obtained by gel polymerisation and has a weight average molecular weight MW in the range of 2 000 000-10 000 000 g/mol, preferably 2 500 000-8 000 000 g/mol, more preferably 3 000 000-6 000 000 g/mol.

15. (canceled)

16. A method to manufacture of paper, board or the like in a process comprising
obtaining a fibre stock comprising recycled cellulosic fibres and having a consistency of ≥2.5 weight-%,
adding the cationic polymeric component and the anionic component of the treatment system according to claim 1 to the fibre stock, wherein the cationic polymeric component and the anionic component are added separately and the cationic polymeric component is added before anionic component,
diluting the fibre stock to a consistency <2.5 weight-%, and
forming the fibre stock into a fibre web and drying the formed fibre web.

17. The method according to claim 16, wherein the fibre stock having a consistency >2.5 weight-% has a cationic demand >300 μeq, conductivity >3 mS/cm, and/or zeta-potential from −15 mV to −2 mV, preferably from −10 mV to −4 mV.

18. The method according to claim 16, wherein the fibre stock comprises at least 80 weight-% of recycled fibres.

19. The method according to claim 16, wherein the cationic polymeric component is added in an amount of 0.2-15 kg/ton dry fibre web.

20. The method according to claim 16, wherein, the formed fibre web has a grammage of at least 80 g/m².

21. The method according to claim 16, wherein the process has a fresh water intake of <5 m³/ton produced paper, board or the like.
